(19) United States
(12) Patent Application Publication
(10) Pub. No.: US 2025/0158975 A1
(43) Pub. Date: May 15, 2025

(54) CONTEXT-AWARE ADAPTIVE CAMERA ACCESS

(71) Applicant: MOTOROLA SOLUTIONS, INC., Chicago, IL (US)

(72) Inventors: Filip Norys, Chrzanow (PL); Grzegorz Gosztyla, Krakow (PL); Pawel G. Nowicki, Wegrzce (PL); Kamil Starzak, Sucha Beskidzka (PL)

(21) Appl. No.: 18/507,875

(22) Filed: Nov. 13, 2023

(51) Int. Cl. H04L 9/40; G06V 20/40; G06V 20/52; H04N 7/18

(52) U.S. Cl. CPC H04L 63/0823; G06V 20/44; G06V 20/52; H04L 63/105; H04N 7/181; G06V 2201/10

(57) ABSTRACT

A system includes non-transitory computer-readable media storing instructions and a processor configured to execute the instructions to receive a request for access to first media from a device. The first media is recorded by a first media-recording device and includes a portion identified as being associated with an event. The event is classified into an event category. The request for access includes an authorization certificate that includes a role. The processor is configured to execute the instructions to, in response to determining the authorization certificate is valid and the role is authorized to access the event category, provide the device access to the portion of the first media and transmit a token to the device. The token includes metadata associated with the portion of the first media and is usable by the device to access a portion of second media. The second media is recorded by a second media-recording device.

### BACKGROUND

Surveillance camera systems may record videos and perform image analysis on the recorded videos to identify objects and events present in the recorded videos. Such camera systems may be capable of distinguishing and tracking various objects such as people, vehicles, and specific items. Such systems may also be capable of detecting various events present in the recorded video.

### BRIEF DESCRIPTION OF THE DRAWINGS

FIG. 1 is a block diagram of an example system for providing context-aware access to media captured by one or more media-recording devices.

FIG. 2 is a block diagram of an example electronic device.

FIG. 3 is a block diagram of an example media-recording device.

FIG. 4 is a schematic illustration of an example user digital certificate for authenticating an electronic device.

FIG. 5 is a schematic illustration of an example organization digital certificate that a media-recording device uses to authenticate an electronic device.

FIG. 6 is a schematic illustration of an example portable access token passable between media-recording devices.

FIG. 7 is a schematic illustration of an example role-permission matrix specifying types of events represented in recorded media and associated access permissions.

FIG. 8 is a flowchart of an example process for granting access to portions of recorded media based on authentication results.

FIGS. 9A and 9B are flowcharts of an example process for granting access to portions of recorded media based on authentication results.

FIGS. 10A and 10B are message sequence charts of example interactions between components of a system providing access to portions of recorded media recorded via media-recording devices.

In the drawings, reference numbers may be reused to identify similar and/or identical elements.

### DETAILED DESCRIPTION

Media-recording devices, such as, for example, surveillance cameras, may be located in areas where incidents, such as, for example, public safety events, occur. Such media-recording devices often contain useful information related to such incidents. Thus, allowing public safety organizations to access the media-recording devices may be beneficial. However, given that such media-recording devices are often owned or operated by individuals or other third-party organizations, it may be difficult for public safety organizations to gain access to the devices or media recorded by the devices and any such granted access likely needs to be associated with access limitations or controls for privacy reasons. To address these and other technical challenges, systems and methods described in this specification dynamically provide role- and context-based access to portions of recorded media using image analysis and cryptographic techniques.

For example, various implementations of the systems described herein provide initial authentication for users to access a media-recording device (or media recorded by such a device) using asymmetric-cryptography-based techniques. The media-recording devices use image analysis techniques, such as, for example, machine-learning-based techniques, to identify events present in the recorded media and provide limited access to only portions of the recorded media that are relevant to each user's specific role. The user may review the portions of the recorded media and identify objects of interest. The media-recording device may also generate and export a portable token (secured using asymmetric-cryptography-based techniques) that may be used to securely access related recorded media associated with other media-recording devices.

Thus, systems and methods described in this specification provide technical benefits by providing controlled, authorized access to media including, for example, across multiple media-recording devices.

A system includes non-transitory computer-readable media storing instructions and an electronic processor configured to execute the instructions to receive a request for access to first media from an electronic device. The first media is recorded by a first media-recording device and includes a portion identified as being associated with an alarm event. The alarm event is classified into an event category. The request for access includes an authorization certificate that includes a role of a user. The electronic processor is configured to execute the instructions to, in response to determining the authorization certificate is valid and the role of the user is authorized to access the event category, provide the electronic device access to the portion of the first media and transmit a token to the electronic device. The token includes metadata associated with the portion of the first media and is usable by the electronic device to access a portion of second media. The second media is recorded by a second media-recording device.

In other features, the electronic processor is configured to execute the instructions to deny the electronic device access to the portion of the first media in response to determining that the role of the user is not authorized to access the event category. In other features, the electronic processor is included in the first media-recording device. In other features, the electronic processor is a first electronic processor and further includes a second electronic processor associated with the second media-recording device. The second electronic processor is configured to receive the token from the electronic device, process the second media and the metadata included in the token to identify the portion of the second media, and provide the portion of the second media to the electronic device.

In other features, the metadata includes a location of the first media-recording device and the second electronic processor is configured to provide the portion of the second media to the electronic device in response to determining that a location of the second media-recording device is within a distance threshold from the location of the first media-recording device. In other features, the metadata includes a time associated with the alarm event and the second electronic processor is configured to process the second media and the metadata included in the token to identify the portion of the second media by identifying the portion of the second media associated with a time range set based on the time associated with the alarm event. In other features, the metadata includes data identifying an object of interest in the portion of the first media and the second electronic processor is configured to process the second media and the metadata included in the token to identify the portion of the second media by identifying the portion of the second media including the object of interest.

In other features, the token is a first token and the second media-recording device is further configured to generate a second token including data from the first token and metadata associated with the portion of the second media and provide the second token to the electronic device. In other features, the electronic device is a mobile device. In other features, the token is signed with a private key assigned to the first media-recording device. In other features, the authorization certificate includes a validity period and the electronic processor is configured to determine whether the authorization certificate is valid by determining whether the validity period has expired.

A method includes transmitting, with an electronic device, a request for access to first media to a first media-recording device. The first media is recorded by the first media-recording device and includes a first portion identified as being associated with an alarm event. The alarm event is classified into an event category. The request for access includes an authorization certificate that includes a role of a user. The method includes, in response to the authorization certificate being valid and the role of the user being authorized to access the event category, receiving, with the electronic device from the first media-recording device, the first portion identified as being associated with the alarm event and a token. The token includes metadata associated with the portion of the media. The method includes transmitting, with the electronic device, the token to a second media-recording device and receiving, with the electronic device from the second media-recording device, a second portion of second media recorded by the second media-recording device based on the metadata included in the token.

In other features, the token is signed with a private key of the first media-recording device. In other features, transmitting the request for accessing includes scanning a code associated with the first media-recording device. In other features, scanning the code associated with the first media-recording device includes scanning a quick response code with a camera included in the electronic device. In other features, transmitting the request for access includes transmitting the request for access over at least one selected from a group consisting of an Internet, a local area network, and a dedicated network between the electronic device and the first media-recording device. In other features, the metadata includes a location of the first media-recording device and receiving the second portion of the second media includes receiving the second portion of the second media from the second media-recording device in response to a location of the second media-recording device being within a distance threshold from the location of the first media-recording device.

Other examples, embodiments, features, and aspects will become apparent by consideration of this specification and accompanying drawings.

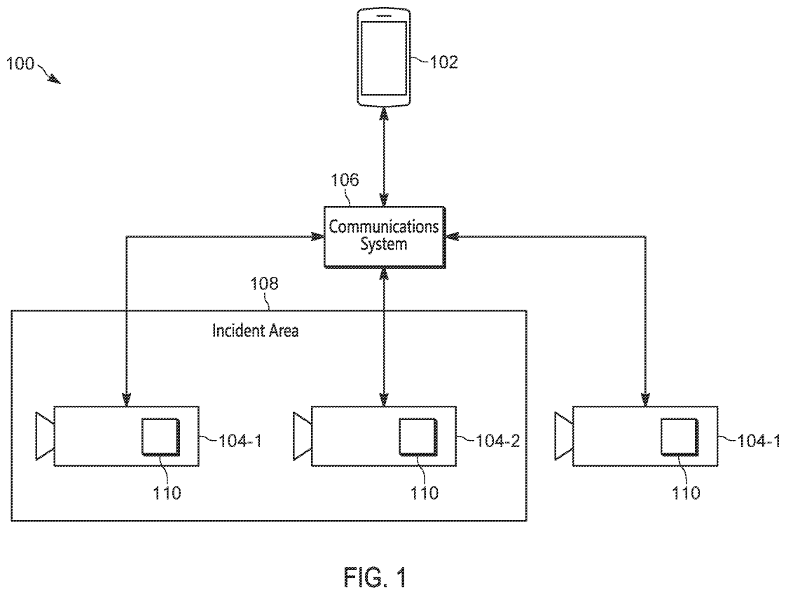

FIG. 1 is a block diagram of an example system 100 for providing context-aware access to media captured by one or more media-recording devices. As shown in FIG. 1, some examples of the system 100 include an electronic device 102 and one or more media-recording device 104. While three media-recording devices 104-1, 104-2, and 104-3 are shown in FIG. 1, the system 100 may include any number n of media-recording devices (including only one). In various implementations, the electronic device 102 may include a mobile device (such as a smartphone, tablet, laptop computer, or mobile radio) and the one or more media-recording devices 104 may include one or more surveillance cameras configured to record video and/or audio media. The electronic device 102 may communicate with the media-recording devices 104 via a communications system 106.

Examples of the communications system 106 include one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 106 includes an optical network, a local area network, and/or a global communication network, such as the Internet.

In some examples, one or more of the media-recording devices 104 include a data carrier device 110. In various implementations, the data carrier device 110 includes a quick-response (QR) code, a bar code, or other type of machine-readable code (e.g., printed on a sticker or other media affixed to an outer housing of the media-recording device 104). In other implementations, the data carrier device 110 includes a radio frequency identification (RFID) tag such as a near field communication (NFC) tag (e.g., affixed to the outer housing of the media-recording device 104). In various implementations, one or more of the media-recording devices 104 may be positioned within an incident area 108. The incident area 108 may define an area around an event detected by one or more of the media-recording devices 104. For example, the incident area 108 may define a radius around the event.

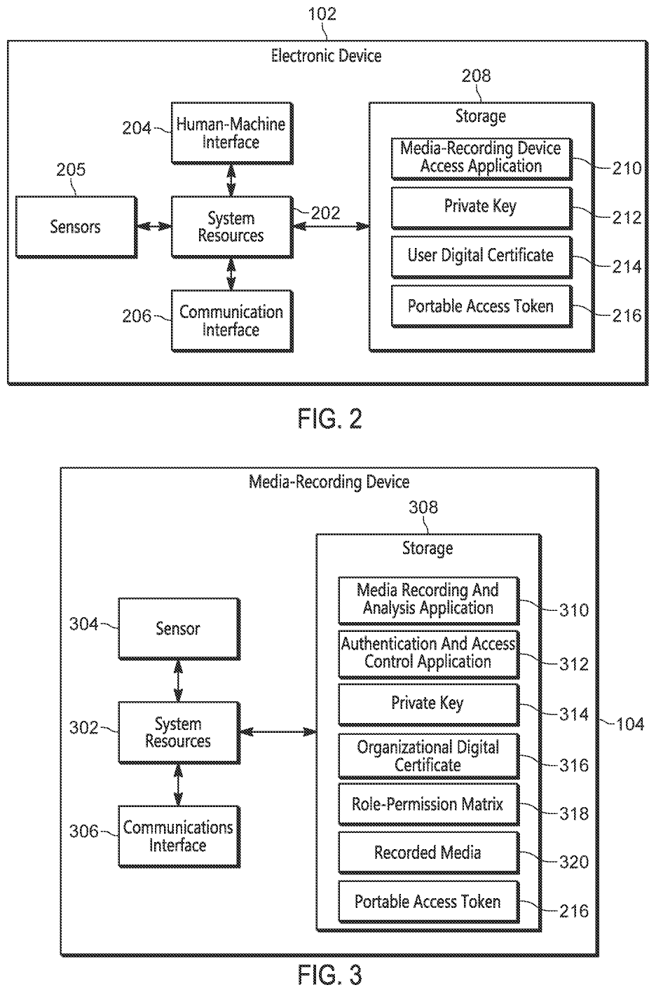

FIG. 2 is a block diagram of an example electronic device 102. In various implementations, the electronic device 102 includes system resources 202, a human-machine interface 204, sensors 205, a communications interface 206, and non-transitory computer-readable storage media, such as, for example, storage 208. In some examples, the system resources 202 include one or more electronic processors, one or more graphics processing units, volatile computer memory, non-volatile computer memory, and/or one or more system buses interconnecting the components of the electronic device 102. In some implementations, the human-machine interface 204 includes one or more input devices (such as a microphone, a push-to-talk button, a keypad, rotary knobs, buttons, and/or a touchscreen) and/or one or more output devices (such as a display, speakers, indicator lights, and/or haptic device).

In some examples, sensors 205 are configured to, among other things, read the data carrier device 110 of the media-recording device 104. For example, the sensors 205 may include image sensors (such as a camera) configured to, among other things, scan a barcode or a QR code, and/or an RFID reader configured to, among other things, read an RFID tag. In various implementations, the communications interface 206 interfaces with the communications system 106 and allows the electronic device 102 to communicate with other devices (such as the media-recording devices 104) over the communications system 106. In some examples, the storage 208 includes a media-recording device access application 210, a private key 212, a user digital certificate 214, and/or a portable access token 216.

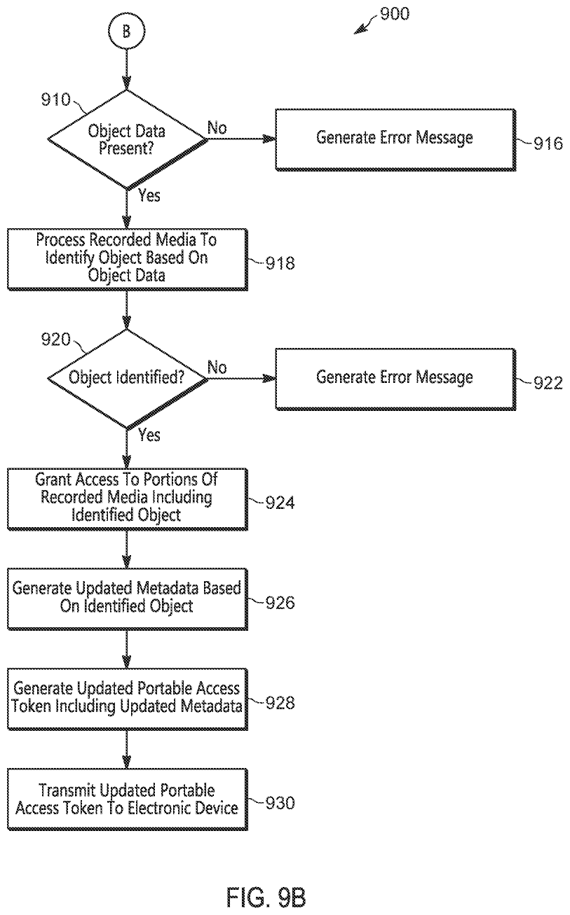

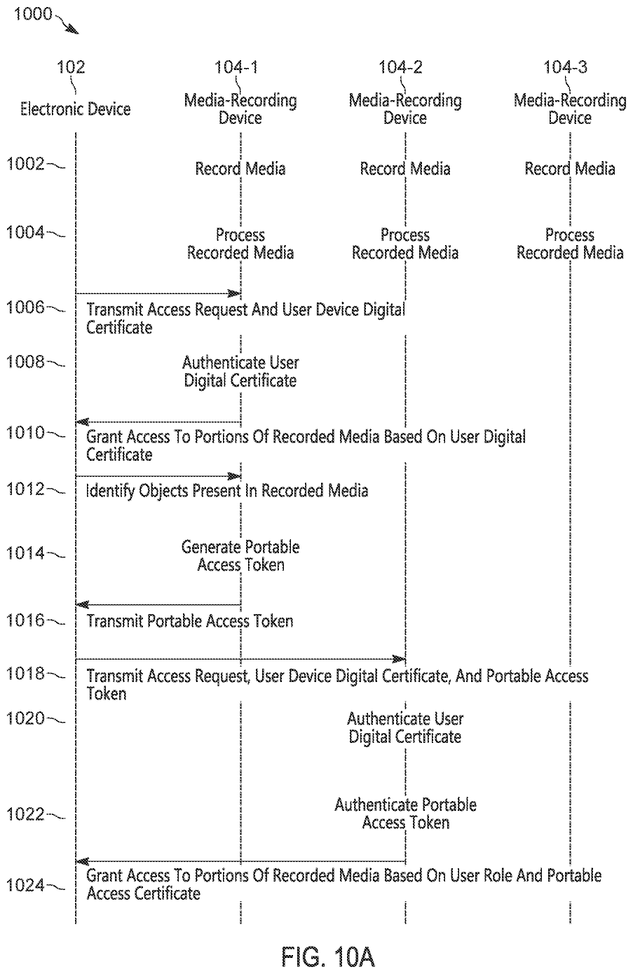

The user may interact with the media-recording device access application 210 via the human-machine interface 204 to access and interact with the media-recording devices 104. Additional functionality of the media-recording device access application 210 are described with reference to FIGS. 8A-9B. In various implementations, the private key 212 may be a cryptographic key (such as a numerical value, an alphanumerical value, or a sequence of bits) used to encrypt and/or decrypt data. In some examples, the private key 212 may be stored in a hardware security module (HSM), a trusted platform module (TPM), and/or a hardware-based secure enclave.

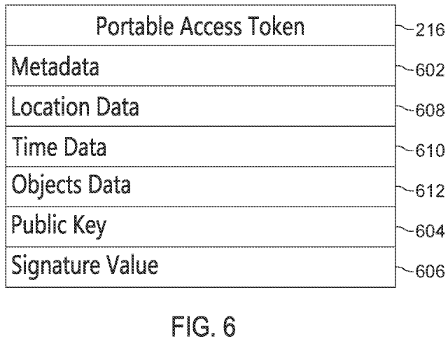

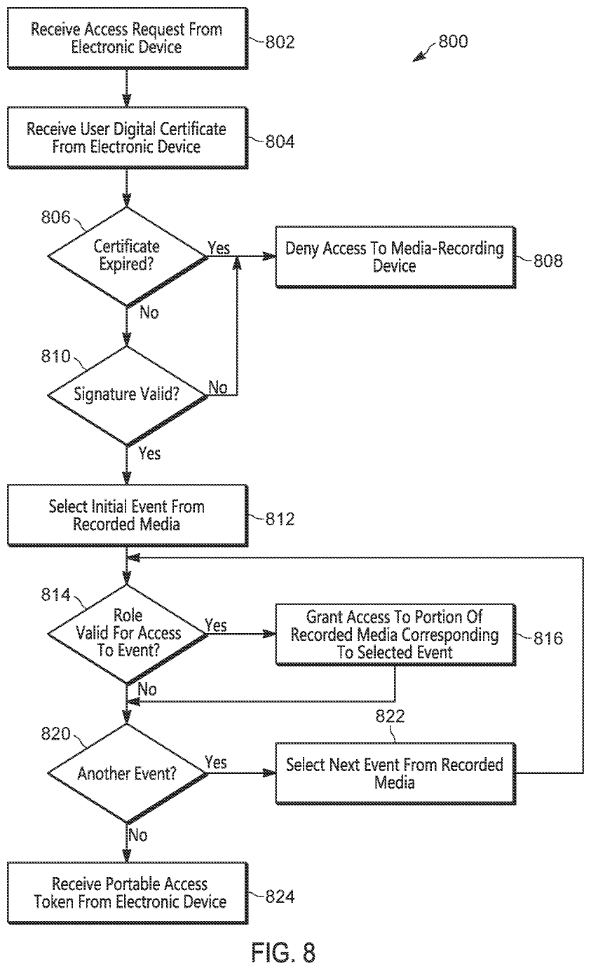

The user digital certificate 214 may be provided to other devices (such as the media-recording devices 104) to verify the identity of the electronic device 102 and/or the user of the electronic device 102. Additional details associated with the user digital certificate 214 are described with reference to FIG. 4. The portable access token 216 may be a digital credential generated by a media-recording device 104. The electronic device 102 may provide the portable access token 216 to other media-recording devices 104 to gain access to portions of media recorded by those devices. Additional details associated with the portable access token 216 are described with reference to FIG. 6.

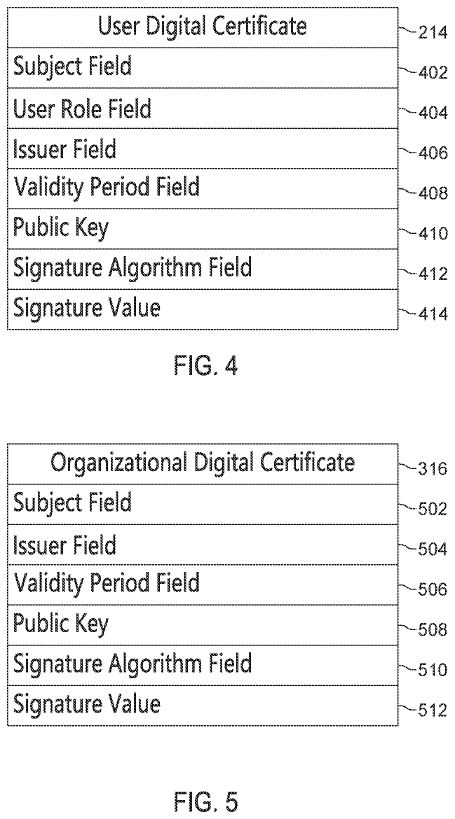

FIG. 3 is a block diagram of an example media-recording device 104. In various implementations, the media-recording device 104 includes system resources 302, sensors 304, a communications interface 306, and non-transitory computer-readable storage media such as storage 308. In some examples, the system resources 302 include one or more electronic processors, one or more graphics processing units, volatile computer memory, non-volatile computer memory, and/or one or more system buses interconnecting the components of the media-recording device 104. In some implementations, sensors 304 include one or more sensors for recording video and/or audio media. For example, the media-recording device 104 may include image sensors (such as charge-coupled device [CCD] sensors and/or complementary metal-oxide-semiconductor [CMOS] sensors), infrared (IR) sensors, motion sensors, sound sensors, thermal imaging sensors, and/or position sensors (such as global navigation satellite system [GNSS] sensors and/or cellular triangulation sensors).

In various implementations, the communications interface 306 interfaces with the communications system 106 and allows the media-recording device 104 to communicate with other devices (such as the electronic device 102 and/or other media-recording devices 104) over the communications system 106. In some examples, the storage 308 includes a media recording and analysis application 310, an authentication and access control application 312, a private key 314, an organizational digital certificate 316, a role-permission matrix 318, recorded media 320, and/or a portable access token 216. The media recording and analysis application 310 may process sensor data from sensors 304 to generate recorded media 320, such as images, videos, and/or audio media. In various implementations, the media recording and analysis application 310 analyzes the recorded media 320 to identify events present in the recorded media 320.

For example, to detect events in recorded video, the media recording and analysis application 310 may process recorded video according to frame differencing techniques, optical flow techniques, background subtraction techniques, deep learning and convolutional neural network-based techniques, temporal analysis techniques, feature matching techniques, and/or histography analysis techniques. Frame differencing techniques take the difference between consecutive frames to detect motion. Significant differences between frames may imply motion and/or changes in the scene. Optical flow techniques estimate the motion vector of pixels in a frame, which may be used to detect moving objects within the frame. Background subtraction involves maintaining a model of the background and subtracting it from frames to detect changes, such as objects present in the frame. Deep learning and convolutional neural network-based techniques involve object detection, classification, and scene segmentation. Convolutional neural networks (CNNs) may be trained on large datasets and categorize objects, faces, actions, and more within the video frames. Temporal analysis techniques analyze sequences of frames to detect patterns over time, such as anomalous events. Frame matching techniques compare extracted features from objects across frames for object recognition and tracking. Histogram analysis compares color or intensity histograms across frames to detect changes or recognize certain events.

In various implementations, to detect events in recorded audio, the media recording and analysis application 310 may process recorded audio according to Fourier transform and spectrogram analysis techniques, deep learning and recurrent neural network-based techniques, sound envelope and amplitude analysis techniques, and/or audio fingerprinting techniques. Fourier transform and spectrogram analysis involves converting audio signals from the time domain to the frequency domain, which enables the detection of specific frequencies in the recorded audio. Recurrent neural networks (RNNs) may be trained to recognize patterns and events in audio streams indicative of certain events. Sound envelope and amplitude analysis may involve monitoring the amplitude envelope of audio to detect sudden spikes or drops, which may be indicative of events, such as, for example, gunshots, car crashes, and/or breaking glass. Audio fingerprinting involves extracting unique features or fingerprints from recorded audio and matching them to known sounds associated with events.

The media recording and analysis application 310 may store information about one or more detected events in the recorded media 320. For example, the media recording and analysis application 310 may generate and store metadata about a recorded event. The metadata may include a type of the event, a location of the event and/or a location of the media-recording device 104 that recorded the event, a time of the event occurring, and/or data about objects detected in the recorded media associated with the event. Additional details associated with the media recording and analysis application 310 are described with reference to FIGS. 8A-9B.

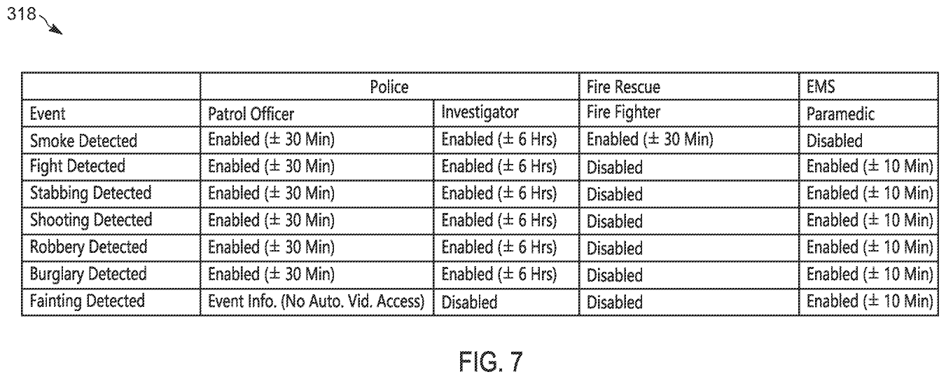

In various implementations, the authentication and access control application 312 dynamically and selectively grants an electronic device 102 access to portions of the recorded media 320 based on the user digital certificate 214 and/or the portable access token 216 provided by the electronic device 102. Additional functionality of the authentication and access control application 312 are described with reference to FIGS. 8A-9B. The private key 314 may be a cryptographic key (such as a numerical value, an alphanumerical value, or a sequence of bits) used to encrypt and/or decrypt data. In some examples, the private key 314 may be stored in a hardware security module (HSM), a trusted platform module (TPM), and/or a hardware-based secure enclave. The organizational digital certificate 316 may be a digital certificate used by the authentication and access control application 312 to authenticate a user digital certificate 214. Additional details associated with the organizational digital certificate 316 are described with reference to FIG. 5.

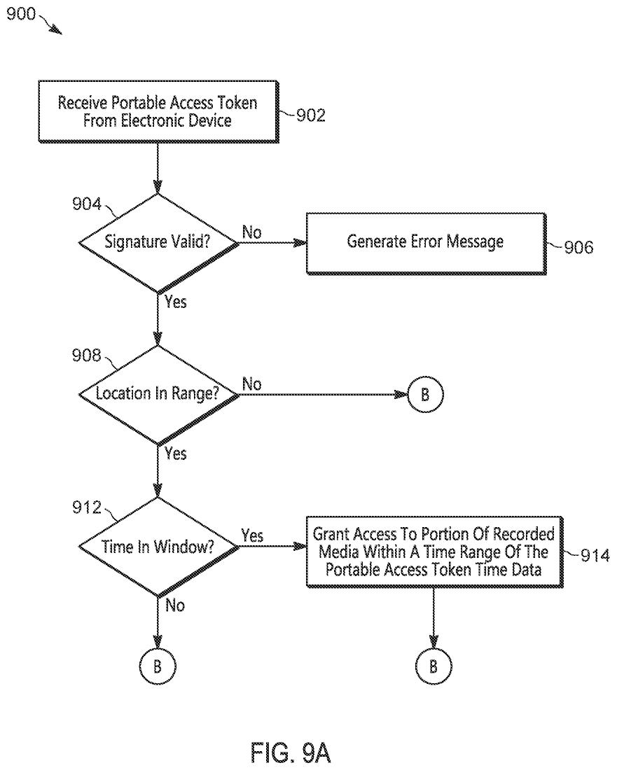

The role-permission matrix 318 specifies one or more types of events and associated access permissions. The access permissions may be specified in terms of user roles. In various implementations, the authentication and access control application 312 determines a user's role based on the user digital certificate 214 and selectively grants the electronic device 102 access to portions of the recorded media 320 associated with events authorized for the user's role. Additional details associated with the role-permission matrix 318 are described with reference to FIG. 7. The authentication and access control application 312 may generate the portable access token 216 to grant the electronic device 102 access to portions of recorded media 320 at other media-recording devices 104. Additional details associated with the portable access token 216 are described with reference to FIG. 6.

While the media recording and analysis application 310, authentication and access control application 312, organizational digital certificate 316, role-permission matrix 318, recorded media 320, and portable access token 216 are shown as being deployed or stored locally at storage 308 of the media-recording device 104, any combination of these elements may be deployed or stored remotely at one or more servers and/or at a cloud-based service that manages and communicates with the media-recording device 104 via the communications system 106.

In various implementations, the media-recording device access application 210 of the electronic device 102 may communicate with software on the media-recording device 104 (such as the media recording and analysis application 310 and/or the authentication and access control application 312) via the communications system 106. The media-recording device access application 210 may initiate a connection with the media-recording device 104 by reading data from the data carrier device 110 with the sensors 205. The data carrier device 110 may contain data facilitating connection between the electronic device 102 and the media-recording device 104. In various implementations, the communications system 106 may include a local network (such as a local Wi-Fi network) generated by the media-recording device 104, and the data carrier device 110 may contain information such as an SSID of the local network.

In some examples, the communications system 106 may include a local short-range wireless network (such as a Bluetooth network) generated by the media-recording device 104, and the data carrier device 110 may contain device pairing information (such as a device identifier of the media-recording device 104 and/or a pairing code). In some implementations, the communications system 106 may include the Internet, and the data carrier device 110 may contain an Internet protocol (IP) address, port number, and/or protocol information (such as information specifying whether to use the transmission control protocol [TCP] or the user datagram protocol [UDP]) for connecting to the media-recording device 104 via the Internet. In various implementations, the software (such as the media recording and analysis application 310 and/or the authentication and access control application 312) of the media-recording device 104 may be deployed to the remotely at one or more servers and/or at a cloud-based service, and the data carrier device 110 may contain information for connecting to the software (such as a URL and/or an IP address for accessing the software at the servers and/or cloud-based service).

In various implementations, the media-recording device access application 210 may be pre-configured with any combination of the previously described data for connecting the electronic device 102 to the media-recording device 104 and accessing software of the media-recording device 104 (locally and/or remotely).

FIG. 4 is a schematic illustration of an example user digital certificate 214 for authenticating an electronic device 102. The user digital certificate 214 may be used to verify the identity of the user of the electronic device 102 (for example, ensuring that the user and/or electronic device 102 belongs to the same entity as the entity identified by organizational digital certificate 316). In various implementations, the device that needs the user digital certificate 214 (such as electronic device 102) first generates an asymmetric key pair consisting of a private key (such as private key 212) and a corresponding public key. The certificate authority generates the user digital certificate 214 using the provided public key and a signature algorithm. In some implementations, the user digital certificate 214 includes a subject field 402, a user role field 404, an issuer field 406, a validity period field 408, a public key 410, a signature algorithm field 412, and/or a signature value 414.

In some examples, the subject field 402 identifies the entity that the user digital certificate 214 represents. For example, the subject field 402 may identify the entity that owns or operates the electronic device 102 or the device 102 or user of the device is otherwise associated with. In various implementations, the entity may be a public safety entity, such as a police department, a fire rescue department, and/or an emergency medical services (EMS) organization. However, the systems and methods described herein have applicability to other industries and types of entities, and implementations described herein are not limited to public safety entities or public safety events. In some implementations, the user role field 404 identifies the role of the user within the entity identified by the subject field 402. For example, when the entity is a police department, the role may identify the user as a patrol officer or an investigator. When the entity is a fire rescue department, the role may identify the user as a firefighter. When the entity is an EMS organization, the role may identify the user as a paramedic.

In various implementations, the issuer field 406 identifies the certificate authority that issued the user digital certificate 214. In some examples, the validity period field 408 identifies start (not before) and/or end (not after) dates specifying when the user digital certificate 214 is valid. In various implementations, the validity period field 408 may indicate a one-year period, a one-month period, a two-week period, a one-week period, or a one-day period. However, other time periods can be used. In some examples, the public key 410 may be the public key used by the certificate authority to generate the user digital certificate 214. The public key 410 may represent one half of a cryptographic key pair. For example, when the public key 410 is used to encrypt a file, a corresponding private key (such as the private key of the certificate authority, the private key 212 of the electronic device 102, and/or the private key 314 of the media-recording device 104) may be used to decrypt the file.

In some implementations, the signature algorithm field 412 specifies the algorithm used by the certificate authority to sign the user digital certificate 214 (or to generate the signature value 414). For example, the algorithm may be a cryptographic hashing algorithm, such as an Rivest-Shamir-Adleman (RSA)-based algorithm (such as RSA with SHA-1, RSA with SHA-256, and/or RSA with SHA-512), a digital signature algorithm (DSA), (such as DSA with SHA-1 and/or DSA with SHA-256) an elliptic curve digital signature algorithm (ECDSA) (such as ECDSA with SHA-256 and/or ECDSA with SHA-512), and/or an Edwards-curve DSA (EdDSA), an RSA signature scheme with appendix—probabilistic signature scheme (RSASSA-PSS). In various implementations, the signature value 414 represents the digital signature of the certificate authority. The certificate authority may generate the signature value 414 by hashing the data of the user digital certificate 214 and encrypting the hashed data (for example, according to algorithms identified by the signature algorithm field 412) using the private key of the certificate authority.

FIG. 5 is a schematic illustration of an example organizational digital certificate 316 that a media-recording device 104 uses to authenticate an electronic device 102. For example, the organizational digital certificate 316 may be issued by the certificate authority and correspond to the user digital certificate 214. The media-recording device 104 may use the organizational digital certificate 316 to determine whether the signature value 414 is valid, thus verifying that the user digital certificate 214 hasn't been tampered with. In some implementations, the device that needs the organizational digital certificate 316 (such as the media-recording device 104) first generates an asymmetric key pair consisting of a private key (such as private key 314) and a corresponding public key. The certificate authority generates the organizational digital certificate 316 using the provided public key and a signature algorithm. In various implementations, the organizational digital certificate 316 includes a subject field 502, an issuer field 504, a validity period field 506, a public key 508, a signature algorithm field 510, and/or a signature value 512.

In various implementations, the subject field 502 identifies the entity that the organizational digital certificate 316 represents. For example, the entity identified by the subject field 502 may be the same entity identified by the subject field 402 of the user digital certificate 214. In some examples, the issuer field 504 identifies the certificate authority that issued the user digital certificate 214. For example, the certificate authority identified by the issuer field 504 may be the same certificate authority identified by the issuer field 406. In some implementations, the validity period field 506 identifies the start and/or end dates specifying when the organizational digital certificate 316 is valid. For example, the validity period field may indicate a one-year period, a one-month period, a two-week period, a one-week period, or a one-day period. Other time periods are also contemplated and can vary depending on, for example, user role, organization, etc. In various implementations, the public key 508 may be the public key used by the certificate authority to generate the organizational digital certificate 316.

In some implementations, the signature algorithm field 510 specifies the algorithm used by the certificate authority to sign the organizational digital certificate 316 (e.g., to generate the signature value 512). For example, the algorithm may be any of the algorithms previously described with reference to signature algorithm field 412. In some examples, the algorithm may be the same algorithm as specified by the signature algorithm field 412. In various implementations, the signature value 512 represents the digital signature of the certificate authority. The certificate authority may generate the signature value 512 by hashing the data of the organizational digital certificate 316 and encrypting the hashed data (for example, according to algorithms identified by the signature algorithm field 412) using the private key of the certificate authority.

As previously described, the media-recording device 104 may use the organizational digital certificate 316 to authenticate the electronic device 102 by validating the user digital certificate 214. For example, the electronic device 102 transmits the user digital certificate 214 stored on the device 102 to the media-recording device 104. The media-recording device 104 may decrypt the signature value 414 using a public key of the certificate authority (for example, a public key from a pre-installed or previously trusted certificate, the public key 410, or the public key 508). The media-recording device 104 independently computes a hash of the contents of the user digital certificate 214 using the cryptographic hashing function used by the certificate authority (for example, according to the signature algorithm specified by the signature algorithm field 412). When the hash value of the decrypted signature value 414 matches the independently computed hash of the contents of the user digital certificate 214, the signature value 414 is deemed valid and the user digital certificate 214 is deemed authentic and trustworthy. When the has value of the decrypted signature value 414 does not match the independently computed has of the contents of the user digital certification 214, the signature value 414 is deemed invalid and no access to recorded media is granted to the electronic device 102.

FIG. 6 is a schematic illustration of an example portable access token 216 that ensures data integrity and authenticity as the portable access token 216 passes metadata between media-recording devices 104. In various implementations, the portable access token 216 includes metadata 602, a public key 604, and a signature value 606. The metadata 602 may include information related to the recorded media 320, such as information related to events identified in the recorded media 320. For example, the media recording and analysis application 310 identifies events in the recorded media 320 and generates metadata 602 (such as location data 608 indicating a location of the media-recording device 104 and/or a location of the event, time data 610 indicating a time that the event occurred, and/or objects data 612 related to objects identified in the recorded media 320) represented by the identified event.

In various implementations, objects data 612 includes information one or more objects identified in the recorded media 320, the characteristics of such objects in the recorded media 320, the behavior of such objects in the recorded media 320, or a combination thereof. For example, the objects data 612 may include an object type or class categorizing the object (e.g., a person, a vehicle, an animal, a weapon, etc.), spatial information of the object (such as the height and width of a bounding box around the object and/or a polygon or a mask defining the shape of the object), behavioral information (such as a trajectory or path of the object and/or data describing actions of the object and/or interactions the object had with other objects), other attributes of the object (such as a color, size, and/or speed of the object), and/or manual annotations or tags, such as, for example, annotations or tags provided manually by a user.

In various implementations, the public key 604 may be represent one half of a cryptographic key pair with the private key 314 representing the other half. In some implementations, the authentication and access control application 312 generates and adds the public key 604 to the portable access token 216. In various implementations, the application and access control application 312 may generate the signature value 606 by computing a cryptographic hash of data of the portable access token 216 (such as the metadata 602 and/or the public key 604). The application and access control application 312 signs (or encrypts) the hash using the private key 314. The second media-recording device 104 receives the portable access token 216, decrypts the signature value 606 (for example, using the public key 604 contained in the portable access token 216), independently computes a hash of the data of the portable access token 216, and compares the computed hash to the decrypted signature value 606. When the computed hash matches the decrypted signature value 606, the portable access token 216 is deemed authentic and trustworthy.

FIG. 7 is a schematic illustration of an example role-permission matrix 318 specifying types of events and associated access permissions. As previously described, the authentication and access control application 312 may determine the a user role based on the user role field 404 of the user digital certificate 214 and may grant the user and/or electronic device 102 holding the user digital certificate 214 access to portions of the recorded media 320 corresponding to event types the user role is authorized to access. As illustrated in FIG. 7, the role-permission matrix 318 may include a variety of roles (such as, for example, “patrol officer,” “investigator,” “firefighter,” and “paramedic”), types of events (such as, for example, “smoke detected,” “fight detected,” “stabbing detected,” “shooting detected,” “robbery detected,” “burglary detected,” and “fainting detected”), and, optionally, the amount access to grant each role for each event type.

For example, as one non-limiting example, when the event is a “robbery detected” event, the role-permission matrix 318 may indicate that the “patrol officer” user role is authorized to access 30 minutes of recorded media before and after the event, the “investigator” user role is authorized to access six hours of recorded media before and after the event, the “firefighter” user role is not authorized to access recorded media related to the event, and the “paramedic” user role is authorized to access 10 minutes of recorded media before and after the event. As also illustrated in FIG. 7 as another non-limiting example, when the event is a “fainting detected” event, the role-permission matrix 318 may indicate that the “patrol officer” user role is authorized to access the event information but is not automatically authorized to access video or other media related to the event, the “investigator” user role is not authorized to access the event, the “firefighter” user role is not authorized to access the event, and the “paramedic” user role is authorized to access 10 minutes of recorded media before and after the event.

FIG. 8 is a flowchart of an example process 800 for authenticating user digital certificates 214 and granting electronic devices 102 access to portions of recorded media 320 based on results of the authentication. In various implementations, portions (or the entirety) of the process 800 may be executed on one or more electronic processors of the media-recording device 104. In some examples, portions of the process 800 may be executed on one or more electronic processors distributed across one or more devices of the system 100 (such as electronic processors of the electronic device 102 and electronic processors of one or more media-recording devices 104) and/or one or more remote servers accessible via the communications system 106.

At block 802, the media-recording device 104 receives an access request from the electronic device 102. For example, in some implementations, the user of the electronic device 102 may initiate an access request by scanning the data carrier device 110 on the media recording device 104 with sensors 205. The media-recording device access application 210 extracts information from the data carrier device 110 for connecting to the media-recording device 104. The media-recording device access application 210 establishes a connection between the electronic device 102 and the media-recording device 104 (for example, over communications system 106) and generates the access request. The media-recording device access application 210 may transmit the access request to the authentication and access control application 312 over the communications system 106. At 804, the media-recording device access application 210 transmits the user digital certificate 214 to the media-recording device 104, and the authentication and access control application 312 accesses the received user digital certificate 214.

At decision block 806, the authentication and access control application 312 determines whether the user digital certificate 214 is expired. For example, the authentication and access control application 312 parses the validity period field 408 to determine whether the present date falls within the validity period indicated by the validity period field 408. In response to determining that the user digital certificate 214 is expired (“YES” at decision block 806), the authentication and access control application 312 denies the electronic device 102 access to the media-recording device 104 at block 808. In response to determining that the user digital certificate 214 is not expired (“NO” at decision block 806), the authentication and access control application 312 determines whether the signature value 414 of the user digital certificate 214 is valid (for example, according to techniques previously discussed with reference to FIGS. 4 and 5). For example, the authentication and access control application 312 may check the authenticity of the user digital certificate.

In response to determining that the signature value 414 is not valid (“NO” at decision block 810), the authentication and access control application 312 denies the electronic device 102 access to the media-recording device 104 at block 808. In response to determining that the signature value 414 is valid (“YES” at decision block 810), the authentication and access control application 312 selects an initial event from the recorded media 320 at block 812. For example, the authentication and access control application 312 accesses metadata from the recorded media 320 and selects the initial event from the metadata. At decision block 814, the authentication and access control application 312 determines whether the role indicated by the user role field 404 of the user digital certificate 214 is valid for access to the selected event. For example, the authentication and access control application 312 parses role-permission matrix 318 to determine whether the role is authorized to access recorded media 320 related to the selected event. In response to determining that the role is valid for accessing the selected event (“YES” at decision block 814), the authentication and access control application 312 grants the media-recording device access application 210 access to the portion of the recorded media 320 corresponding to the selected event at block 816. In various implementations, the portion of the recorded media 320 may be determined based on role-permission matrix 318 (e.g., for a specified period of time before and/or after the event).

In response to determining that the role is not valid for accessing the selected event (“NO” at decision block 814), the authentication and access control application 312 determines whether another unprocessed event is present in the recorded media 320. In response to determining that another unprocessed event is present in the recorded media 320 (“YES” at decision block 820), the authentication and access control application 312 selects the next unprocessed event present in the recorded media 320 at block 822 and the process 800 proceeds back to decision block 814. After determining that another unprocessed event is not present in the recorded media 320 (“NO” at decision block 820), the authentication and access control application 312 (optionally) receives a portable access token 216 from the electronic device 102 at block 824.

In various implementations, the access request received at block 802 includes a request for access to specific types of events and/or access to events occurring during a specified time period, and the process 800 bypasses blocks 812-822. Instead of or in addition to performing blocks 812-822, the authentication and access control application 312 may determine whether the role is valid for access to the events meeting the criteria specified in the access request and, in response to determining that the role is valid for access, grant the media-recording access application 210 access to the portions of the recorded media 320 corresponding to the authorized events.

FIGS. 9A and 9B are flowcharts of an example process 900 for authenticating portable access tokens 216 and granting electronic devices 102 access to portions of recorded media 320 based on the results of the authentication. In various implementations, portions (or the entirety) of the process 900 may be executed on one or more electronic processors of the media-recording device 104. In some examples, portions of the process 900 may be executed on one or more electronic processors distributed across one or more devices of the system 100 (such as electronic processors of the electronic device 102 and electronic processors of one or more media-recording devices 104) and/or one or more remote servers accessible via the communications system 106. At block 902, the authentication and access control application 312 receives a portable access token 216 from an electronic device 102.

In various implementations, the portable access token 216 may be generated after the authentication and access control application 312 of one of the media-recording devices 104 grants the media-recording device access application 210 of the electronic device 102 access to one or more portions of the recorded media 320. For example, the authentication and access control application 312 grants the electronic device 102 access to portions of the recorded media 320 according to techniques previously described with reference to process 800 and/or generates the portable access token 216 according to techniques previously described with reference to FIG. 6. Accordingly, in some examples, process 900 may begin after the electronic device 102 is authenticated according to process 800 and grant access to additional portions of the recorded media 320 not granted by process 800. In various implementations, process 900 may be performed before, independent of, or concurrent with process 800 to grant access to portions of the recorded media 320.

At decision block 904, the authentication and access control application 312 determines whether the signature value 606 of the portable access token 216 is valid (for example, according to processes previously described with reference to FIG. 6). In response to determining that the signature value 606 is not valid (“NO” at decision block 904), the authentication and access control application 312 generates an error message at block 906. In various implementations, the authentication and access control application 312 transmits the error message to the media-recording device access application 210 and the media-recording device access application 210 outputs the error message via a graphical user interface. For example, the error message may indicate that the portable access token 216 is not valid. In response to determining that the signature value 606 is valid (“YES” at decision block 904), the authentication and access control application 312 determines whether the media-recording device 104 is within a range of a location indicated by the location data 608 of the portable access token 216 at decision block 908. In response to determining that the media-recording device 104 is not within the range (“NO” at decision block 908), the process 900 proceeds to decision block 910.

In response to determining that the media-recording device 104 is within the range (“YES” at decision block 908), the authentication and access control application 312 determines whether a present time is within a window of time from the time indicated by the time data 610 at decision block 912. In response to determining that the present time is within the window (“YES” at decision block 912), the authentication and access control application 312 grants the media-recording device access application 210 access to a portion of the recorded media 320 that is within a time range of the time indicated by the time data 610 at block 914 and the process 900 proceeds to decision block 910. In response to determining that the present time is not within the window (“NO” at decision block 910), the authentication and access control application 312 determines whether objects data 612 is present in the portable access token 216 at decision block 910.

In response to determining that objects data 612 is not present in portable access token 216 (“NO” at decision block 910, the authentication and access control application 312 generates an error message at block 916. In various implementations, the authentication and access control application 312 transmits the error message to the media-recording device access application 210 and the media-recording device access application 210 outputs the error message via the graphical user interface. For example, the error message may indicate that the object data is not present in the portable access token 216. In response to determining that objects data 612 is present in the portable access token 216 (“YES” at decision block 910), the authentication and access control application 312 passes the objects data 612 to the media recording and analysis application 310 and the media recording and analysis application 310 processes the recorded media 320 to identify objects in the recorded media 320 based on the objects data 612 (at block 918).

At decision block 920, the authentication and access control application 312 queries the media recording and analysis application 310 to determine whether any objects have been identified. In response to the authentication and access control application 312 determining that no objects have been identified by the media recording and analysis application 310 (“NO” at decision block 920), the authentication and access control application 312 generates an error message at block 922. In various implementations, the authentication and access control application 312 transmits the error message to the media-recording device access application 210 and the media-recording device access application 210 outputs the error message via the graphical user interface. For example, the error message may indicate that the objects are not present in the recorded media. In response to the authentication and access control application 312 determining that objects corresponding to objects data 612 have been identified in the recorded media 320 (“YES” at decision block 920), the authentication and access control application 312 grants the media-recording device access application 210 access to portions of the recorded media 320 including the identified object at block 924.

At block 926, the authentication and access control application 312 calls the media recording and analysis application 310 to generate updated metadata based on the identified object in the recorded media 320. For example, the media recording and analysis application 310 updates the object data 612 to include details related to the objects identified in the recorded media 320. At block 928, the authentication and access control application 312 generates an updated portable access token that includes the updated metadata. At block 930, the authentication and access control application 312 transmits the portable access token to the electronic device 102, and the media-recording device access application 210 saves the updated portable access to token to storage 208.

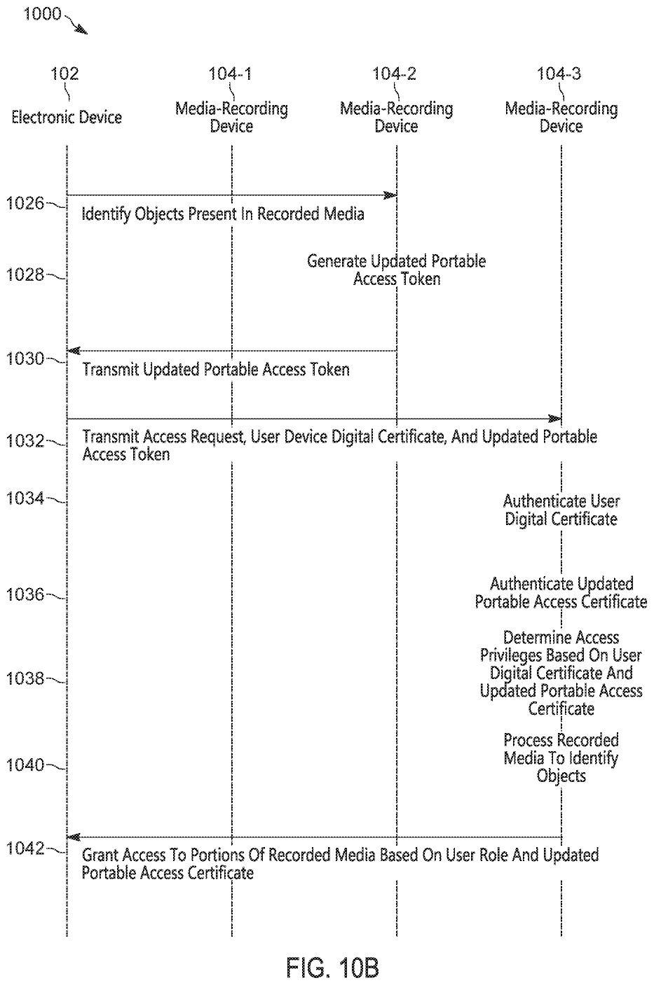

FIGS. 10A and 10B are message sequence charts of example interactions or events 1000 between components of the system 100 as part of providing provide access to portions of recorded media recorded via the media-recording devices 104. At event 1002, media-recording devices 104-1, 104-2, and 104-3 record media and store the recorded media as recorded media 320 (for example, at each respective media-recording device 104 and/or at one or more remote servers and/or cloud-based services). For example, at each media-recording device 104-1, 104-2, and 104-3, the media recording and analysis application 310 processes signals from sensors 304 to generate and store recorded media 320. At event 1004, the media recording and analysis application 310 of each media-recording device 104-1, 104-2, and 104-3 processes the recorded media 320 to identify events (for example, according to previously described techniques). At event 1006, the media-recording device access application 210 at the electronic device 102 transmits an access request and a user digital certificate 214 to the media-recording device 104-1.

At event 1008, the authentication and access control application 312 of media-recording device 104-1 authenticates the user digital certificate 214 (for example, according to previously techniques). At event 1010, the authentication and access control application 312 of media-recording device 104-1 grants the media-recording device access application 210 access to portions of the recorded media 320 of the media-recording device 104-1 based on the user role field 404 of the user digital certificate 214 and the role-permission matrix 318. For example, the authentication and access control application 312 grants the media-recording device access application 210 access to portions of the recorded media 320 of the media-recording device 104-1 associated with events that the role indicated by the user role field 404 is authorized to access. At event 1012, the media-recording device access application 210 accesses the portions of the recorded media 320 of the media recording device 104-1 and identifies objects of interest present in the recorded media 320 (for example, via the media recording and analysis application 310). The media recording and analysis application 310 of the media-recording device 104 generates metadata related to the annotated objects (for example, according to previously described techniques).

At event 1014, the authentication and access control application 312 of the media-recording device 104-1 generates a portable access token 216. In various implementations, the portable access token 216 includes metadata 602, such as location data 608 indicating the location of the media-recording device 104-1 and/or event, time data 610 indicating the time the event occurred, and/or objects data 612 including metadata about the annotated object. At event 1016, the authentication and access control application 312 of the media-recording device 104 transmits the portable access token 216 to the electronic device 102, and the media-recording device access application 210 stores the portable access token 216 in storage 208. At event 1018, the media-recording device access application 210 transmits an access request, the user digital certificate 214, and the portable access token 216 to the media-recording device 104-2.

At event 1020, the authentication and access control application 312 of the media-recording device 104-2 authenticates the user digital certificate 214. At event 1022, the authentication and access control application 312 authenticates the portable access token 216. At event 1024, the authentication and access control application 312 grants the media-recording device access application 210 access to portions of the recorded media 320 of the media-recording device 104-2 based on the role indicated by the user role field 404 of the user digital certificate 214 and/or the metadata 602 of the portable access token 216. For example, the authentication and access control application 312 of the media-recording device 104-2 may determine that the recorded media 320 does not contain any events that the user role is authorized to access but determine that the media-recording device 104-2 is within the incident area 108 (for example, based on an analysis of the location data 608 of the portable access token 216). In response to determining that the media-recording device 104-2 is within the incident area 108, the authentication and access control application 312 of the media-recording device 104-2 grants the media-recording device access application 210 access to portions of the recorded media 320 of the media-recording device 104-2 within a time period of the time of the event as indicated by the time data 610 of the portable access token 216.

At event 1026, the user views the portions of the recorded media 320 of the media-recording device 104-2 via the media-recording device access application 210, identifies objects present in the portions of the recorded media 320, and annotates the objects as objects of interest. The media recording and analysis application 310 of the media-recording device 104-2 generates metadata related to the annotated objects. At event 1028, the authentication and access control application 312 of the media-recording device 104-2 generates an updated portable access token. For example, the authentication and access control application 312 adds the metadata related to the annotated objects to the objects data 612 of the portable access token 216 and/or generates a new portable access token 216 including the updated objects data 612. At event 1030, the authentication and access control application 312 transmits the updated portable access token 216 to the electronic device 102 and the media-recording device access application 210 stores the updated portable access token 216 in storage 208.

At event 1032, the media recording and analysis application 310 transmits an access request, the user digital certificate 214, and the updated portable access token 216 to the media-recording device 104-3. At event 1034, the authentication and access control application 312 of the media-recording device 104-3 authenticates the user digital certificate 214. At event 1036, the authentication and access control application 312 of the media-recording device 104-3 authenticates the updated portable access token 216. At event 1038, the authentication and access control application 312 of the media-recording device 104-3 determines access privileges for the media-recording device access application 210 based on the user digital certificate 214 and the updated portable access token 216. For example, the authentication and access control application 312 determines that the recorded media 320 does not contain any events that the role indicated by the user role field 404 of the user digital certificate is authorized to access. The authentication and access control application 312 may also determine that the location of the media-recording device 104-3 is not within range of the event or the media-recording device 104-1 used to record the event (as indicated by the location data 608 of the portable access token). Thus, the authentication and access control application 312 does not grant the media-recording device access application 210 to the recorded media 320 based on these criteria.

However, the authentication and access control application 312 may recognize a presence of objects data 612 in the portable access token 216. In response, the authentication and access control application 312 may call the media recording and analysis application 310 to process the recorded media 320 to check whether any of the objects identified by the objects data 612 is present in the recorded media 320 at event 1040. When the objects are present in the recorded media 320, the media recording and analysis application 310 notifies the authentication and access control application 312 and the authentication and access control application 312 grants the media-recording device access application 210 access to the portions of the recorded media 320 containing the objects at event 1042.

In the foregoing specification, specific implementations have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementations such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some implementations may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the written description and the claims, one or more steps within any given method may be executed in a different order—or steps may be executed concurrently—without altering the principles of this disclosure. Unless otherwise indicated, the numbering or other labeling of instructions or method steps is done for convenient reference and does not necessarily indicate a fixed sequencing or ordering. In the figures, the directions of arrows generally demonstrates the flow of information—such as data or instructions. However, the direction of an arrow does not imply that information is not being transmitted in the reverse direction. The phrase “at least one of A, B, and C” should be construed to indicate a logical relationship (A OR B OR C), where OR is a non-exclusive logical OR, and should not be construed to mean “at least one of A, at least one of B, and at least one of C.”

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some implementations, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or they may be distributed among different computing devices—such as computing devices interconnected by one or more networks or other communications systems.

In the claims, if an apparatus or system is claimed as including one or more electronic processors (and/or other elements) configured in a certain manner (for example, to make multiple determinations), the claim or claimed element should be interpreted as meaning one or more of the electronic processors (and/or other elements) where any combination of the one or more electronic processors (and/or other elements) may be configured to make some or all of the multiple determinations—for example, collectively. To reiterate, those electronic processors and the processing may be distributed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system comprising:
non-transitory computer-readable media storing instructions; and
an electronic processor configured to execute the instructions to:
receive a request for access to first media from an electronic device, the first media recorded by a first media-recording device, the first media including a portion identified as being associated with an alarm event, the alarm event classified into an event category, the request for access including an authorization certificate, the authorization certificate including a role of a user, and
in response to determining the authorization certificate is valid and the role of the user is authorized to access the event category:
provide the electronic device access to the portion of the first media, and
transmit a token to the electronic device, the token including metadata associated with the portion of the first media, the token usable by the electronic device to access a portion of second media, the second media recorded by a second media-recording device.

2. The system of claim 1, wherein the electronic processor is configured to execute the instructions to deny the electronic device access to the portion of the first media in response to determining that the role of the user is not authorized to access the event category.

3. The system of claim 1, wherein the electronic processor is included in the first media-recording device.

4. The system of claim 1, wherein the electronic processor is a first electronic processor and further comprising a second electronic processor associated with the second media-recording device, the second electronic processor configured to:
receive the token from the electronic device;
process the second media and the metadata included in the token to identify the portion of the second media; and
provide the portion of the second media to the electronic device.

5. The system of claim 4, wherein:
the metadata includes a location of the first media-recording device; and
the second electronic processor is configured to provide the portion of the second media to the electronic device in response to determining that a location of the second media-recording device is within a distance threshold from the location of the first media-recording device.

6. The system of claim 4, wherein:
the metadata includes a time associated with the alarm event; and
the second electronic processor is configured to process the second media and the metadata included in the token to identify the portion of the second media by identifying the portion of the second media associated with a time range set based on the time associated with the alarm event.

7. The system of claim 4, wherein:
the metadata includes data identifying an object of interest in the portion of the first media; and
wherein the second electronic processor is configured to process the second media and the metadata included in the token to identify the portion of the second media by identifying the portion of the second media including the object of interest.

8. The system of claim 4, wherein the token is a first token and wherein the second media-recording device is further configured to:
generate a second token including data from the first token and metadata associated with the portion of the second media; and
provide the second token to the electronic device.

9. The system of claim 1, wherein the electronic device is a mobile device.

10. The system of claim 1, wherein the token is signed with a private key assigned to the first media-recording device.

11. The system of claim 1, wherein the authorization certificate includes a validity period and wherein the electronic processor is configured to determine whether the authorization certificate is valid by determining whether the validity period has expired.

12. A method comprising:
transmitting, with an electronic device, a request for access to first media to a first media-recording device, the first media recorded by the first media-recording device, the first media including a first portion identified as being associated with an alarm event, the alarm event classified into an event category, the request for access including an authorization certificate, the authorization certificate including a role of a user;
in response to the authorization certificate being valid and the role of the user being authorized to access the event category, receiving, with the electronic device from the first media-recording device, the first portion identified as being associated with the alarm event and a token, the token including metadata associated with the portion of the media;
transmitting, with the electronic device, the token to a second media-recording device; and
receiving, with the electronic device from the second media-recording device, a second portion of second media recorded by the second media-recording device based on the metadata included in the token.

13. The method of claim 12, wherein the token is signed with a private key of the first media-recording device.

14. The method of claim 12, wherein transmitting the request for accessing includes scanning a code associated with the first media-recording device.

15. The method of claim 14, wherein scanning the code associated with the first media-recording device includes scanning a quick response code with a camera included in the electronic device.

16. The method of claim 12, wherein transmitting the request for access includes transmitting the request for access over at least one selected from a group consisting of an Internet, a local area network, and a dedicated network between the electronic device and the first media-recording device.

17. The method of claim 12, wherein:
the metadata includes a location of the first media-recording device; and
receiving the second portion of the second media includes receiving the second portion of the second media from the second media-recording device in response to a location of the second media-recording device being within a distance threshold from the location of the first media-recording device.

18. The method of claim 12, wherein:
the metadata includes a time associated with the alarm event; and
receiving the second portion of the second media includes receiving a portion of the second media associated with a time range set based on the time associated with the alarm event.

19. The method of claim 12, wherein:
the metadata includes data associated with an object of interest in the portion of the first media; and
receiving the second portion of the second media includes receiving a portion of the second media including the object of interest.

20. The method of claim 12, wherein the token is a first token and further comprising receiving, with the electronic device from the second media-recording device, a second token, the second token including data from the first token and metadata associated with the second portion of the second media.
